(19) United States
(12) Patent Application Publication
(10) Pub. No.: US 2025/0358010 A1
(43) Pub. Date: Nov. 20, 2025

(54) OPTICAL COMMUNICATION NETWORK AND METHOD FOR MANUFACTURING SAME

(71) Applicant: Fujikura Ltd., Tokyo (JP)

(72) Inventor: Takuya Oda, Sakura-shi (JP)

(73) Assignee: Fujikura Ltd., Tokyo (JP)

(21) Appl. No.: 18/865,463

(22) PCT Filed: Feb. 13, 2023
(86) PCT No.: PCT/JP2023/004749

§ 371 Date: Nov. 13, 2024

(30) Foreign Application Priority Data
Jun. 8, 2022 (JP) 2022-093339

(51) Int. Cl. H04B 10/27; G02B 6/02; H04B 10/25

(52) U.S. Cl. CPC H04B 10/271; G02B 6/02042; H04B 10/25

(57) ABSTRACT

An optical communication network includes three or more nodes and a domain in which each of transmission paths, that connects two of the three or more nodes within the domain, is constituted by a multi-core fiber or a multi-core fiber connected body in which positions of markers on both end surfaces of the multi-core fiber connected body are swapped.

### BACKGROUND

### Technical Field

The present invention relates to an optical communication network using a multi-core fiber and a method for manufacturing such an optical communication network.

### Discussion of the Background

In the field of optical communications, a multi-core fiber including a plurality of cores is widely used. A document disclosing the multi-core fiber is, for example, Patent Literature 1.

### Patent Literature

Patent Literature 1: JP Patent Publication No. 2019-152866

### SUMMARY

The inventors of the present application found that using a multi-core fiber connected body as a transmission path of an optical communication network may raise the following.

That is, assume a case where after one end surface Σ1 of a multi-core fiber connected body C has been connected to a first node, the other end surface Σ2 of the multi-core fiber connected body C is connected to a second node. In this case, an operator who connects the other end surface Σ2 of the multi-core fiber connected body C to the second node needs to have two pieces of knowledge. The first one is knowledge on to which ports of the first node the respective cores on the one end surface Σ1 of the multi-core fiber connected body C are connected. The second one is knowledge on identification of whether the multi-core fiber connected body C is a normal-type multi-core fiber connected body Cs in which positions of the markers are swapped on both end surfaces thereof or a reverse-type multi-core fiber connected body Cc in which positions of markers are common on both end surfaces thereof. This is because the ports of the second node to which the respective cores on the other end surface Σ2 of the multi-core fiber connected body C are to be connected differ depending on these pieces of knowledge.

For example, on the assumption that the normal-type multi-core fiber connected body Cs is used as the multi-core fiber connected body C, in a case where a core a1 on the one end surface Σ1 is connected to a transmission port Tx1, a core a1 on the other end surface Σ2 needs to be connected to a reception port Rx1, as illustrated in (a) of FIG. 22. In contrast, on the assumption that the multi-core fiber connected body Cc is used as the multi-core fiber connected body C, in a case where a core a1 on the one end surface Σ1 is connected to the transmission port Tx1, a core a2 on the other end surface Σ2 needs to be connected to the reception port Rx1, as illustrated in (b) of FIG. 22.

As described above, in a case where a multi-core fiber connected body is used as a transmission path of an optical communication network, an operator needs to have the two pieces of knowledge described above for an operation of connecting the multi-core fiber connected body to a node. This is why it has been difficult to construct or design an optical communication network including a multi-core fiber connected body as a transmission path or to increase or decrease the number of nodes.

One or more embodiments provide an optical communication network or a method for manufacturing an optical communication network, each of in which it is easy to construct or design the optical communication network or to perform a connection operation for increasing or decreasing the number of nodes.

An optical communication network in accordance with one or more embodiments is an optical communication network including not less than three nodes, the optical communication network including a domain in which all of a plurality of transmission paths that connect nodes within the domain are constituted by multi-core fibers or multi-core fiber connected bodies in which positions of markers on both end surfaces of the multi-core fiber connected bodies are swapped or a domain in which all of a plurality of transmission paths that connect nodes within the domain are constituted by multi-core fiber connected bodies in which positions of markers on both end surfaces of the multi-core fiber connected bodies are not swapped.

A method for manufacturing an optical communication network, in accordance with one or more embodiments is a method for manufacturing an optical communication network including not less than three nodes, the method including the step of, as all of a plurality of transmission paths connecting nodes within a specific domain, selecting multi-core fibers or multi-core fiber connected bodies in which positions of markers on both end surfaces of the multi-core fiber connected bodies are swapped or selecting multi-core fiber connected bodies in which positions of markers on both end surfaces of the multi-core fiber connected bodies are not swapped (creating each of transmission paths, that connects two of the three or more nodes within a domain, with a multi-core fiber or a multi-core fiber connected body in which positions of markers on both end surfaces of the multi-core fiber connected body are either swapped or not swapped).

According to one or more embodiments, it is possible to achieve an optical communication network or a method for manufacturing an optical communication network, in each of which it is easy to construct or design the optical communication network or to perform a connection operation for increasing or decreasing the number of nodes.

### BRIEF DESCRIPTION OF THE DRAWINGS

FIG. 1 shows a view illustrating a multi-core fiber used in each of embodiments, a side view illustrating the multi-core fiber, a front view illustrating one end surface of the multi-core fiber, and a front view illustrating the other end surface of the multi-core fiber.

FIG. 2 shows a view illustrating a normal-type multi-core fiber connected body used in Example 1 of one or more embodiments, a side view illustrating the normal-type multi-core fiber connected body, a front view illustrating one end surface of the normal-type multi-core fiber connected body, and a front view illustrating the other end surface of the normal-type multi-core fiber connected body.

FIG. 3 shows a view illustrating a reverse-type multi-core fiber connected body used in Example 2 of one or more embodiments, a side view illustrating the reverse-type multi-core fiber connected body, a front view illustrating one end surface of the reverse-type multi-core fiber connected body, and a front view illustrating the other end surface of the reverse-type multi-core fiber connected body.

FIG. 4 is a block diagram illustrating a first specific example of an optical communication network in accordance with Example 1 of one or more embodiments.

FIG. 5 is a block diagram illustrating a second specific example of the optical communication network in accordance with Example 1 of one or more embodiments.

FIG. 6 is a block diagram illustrating a third specific example of the optical communication network in accordance with Example 1 of one or more embodiments.

FIG. 7 is a block diagram illustrating a fourth specific example of the optical communication network in accordance with Example 1 of one or more embodiments.

FIG. 8 is a block diagram illustrating a fifth specific example of the optical communication network in accordance with Example 1 of one or more embodiments.

FIG. 9 is a block diagram illustrating a sixth specific example of the optical communication network in accordance with Example 1 of one or more embodiments.

FIG. 10 is a block diagram illustrating a seventh specific example of the optical communication network in accordance with Example 1 of one or more embodiments.

FIG. 11 is a block diagram illustrating an eighth specific example of the optical communication network in accordance with Example 1 of one or more embodiments.

FIG. 12 is a block diagram illustrating a first specific example of an optical communication network in accordance with Example 2 of one or more embodiments.

FIG. 13 is a block diagram illustrating a second specific example of the optical communication network in accordance with Example 2 of one or more embodiments.

FIG. 14 is a block diagram illustrating a third specific example of the optical communication network in accordance with Example 2 of one or more embodiments.

FIG. 15 is a block diagram illustrating a fourth specific example of the optical communication network in accordance with Example 2 of one or more embodiments.

FIG. 16 is a block diagram illustrating a fifth specific example of the optical communication network in accordance with Example 2 of one or more embodiments.

FIG. 17 is a block diagram illustrating a sixth specific example of the optical communication network in accordance with Example 2 of one or more embodiments.

FIG. 18 is a block diagram illustrating a seventh specific example of the optical communication network in accordance with Example 2 of one or more embodiments.

FIG. 19 is a block diagram illustrating an eighth specific example of the optical communication network in accordance with Example 2 of one or more embodiments.

FIG. 20 shows a view schematically illustrating a configuration of a typical multi-core fiber, a view schematically illustrating how the multi-core fiber illustrated in (a) is normally connected, and a view schematically illustrating how the multi-core fiber illustrated in (a) is reversely connected.

FIG. 21 shows a view schematically illustrating a configuration of a typical normal-type multi-core fiber connected bod and a view schematically illustrating a configuration of a typical reverse-type multi-core fiber connected body.

FIG. 22 shows a view schematically illustrating how both ends of a typical normal-type multi-core fiber connected body are connected to nodes and view schematically illustrating how both ends of a typical reverse-type multi-core fiber connected body are connected to nodes.

### DESCRIPTION OF THE EMBODIMENTS

The inventors of the present application considered using a multi-core fiber as a transmission path of an optical communication network in order to satisfy a need for increasing a capacity of the optical communication network. During the consideration, the inventors of the present application found that using a multi-core fiber as a transmission path of the optical communication network may raise the following.

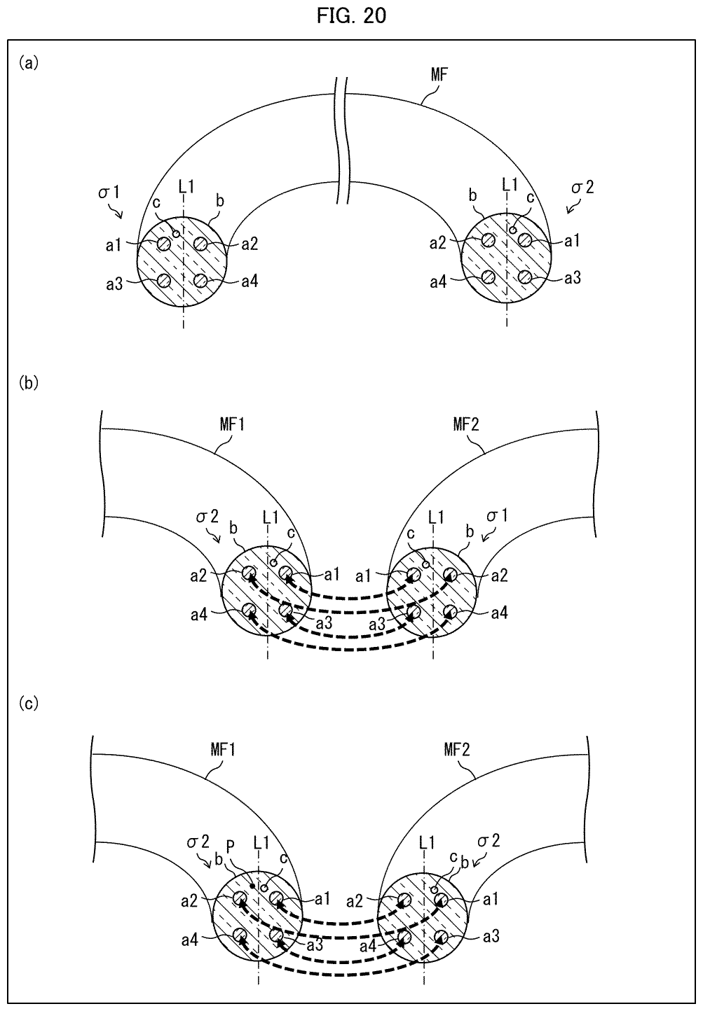

The multi-core fiber is often provided with a marker used to identify cores. An example of such a multi-core fiber is illustrated in (a) of FIG. 20. The multi-core fiber MF illustrated in (a) of FIG. 20 includes four cores a1 to a4 and one marker c. The cores a1 to a4 are arranged so as to be axisymmetric with respect to a straight line L1 on each of the end surfaces σ1 and σ2. The center of the marker c is arranged so as to be located in a position other than the straight line L1 on each of the end surfaces σ1 and σ2. This makes it possible to identify the cores a1 to a4 with reference to the marker c. The core a1 is the core closest to the marker c, the core a2 is the core second closest to the marker c, the core a3 is the core third closest to the marker c, and the core a4 is the core farthest from the marker c.

In a case where the both end surfaces σ1 and σ2 of the multi-core fiber MF are each viewed from the front with the multi-core fiber MF undergoing no twisting, the marker c is located in the right of the straight line L1 on the one end surface σ1, and the marker c is located in the left of the straight line L1 on the other end surface σ2. That is, in a case where the both end surfaces σ1 and σ2 of the multi-core fiber MF are each viewed from the front with the multi-core fiber MF undergoing no twisting, the positions of the markers c are reversed with respect to the straight line L1, which the axis with respect to which the cores a1 to a4 are axisymmetric.

The following will discuss connection of two multi-core fibers MF1 and MF2, taking, as an example, the multi-core fiber MF illustrated in (a) of FIG. 20. In a case where an end surface σ2 of the first multi-core fiber MF1 and an end surface σ1 of the second multi-core fiber MF2 are connected to each other, as illustrated in (b) of FIG. 20, the positions of the cores a1 to a4 can be aligned and the positions of the markers c can be aligned. In a case where the end surface σ2 of the first multi-core fiber MF1 and the end surface σ2 of the second multi-core fiber MF2 are connected to each other, as illustrated in (c) of FIG. 20, aligning the positions of the cores a1 to a4 precludes the positions of the markers c from being aligned. In this case, on the end surface σ2 of the first multi-core fiber MF1, the center of the marker c of the second multi-core fiber MF2 is connected to a point P which is axisymmetric to the center of the marker c of the first multi-core fiber MF1 with respect to the straight line L1.

In the connection illustrated in (b) of FIG. 20, (1) the core a1 of the first multi-core fiber MF1 is connected to the core a1 of the second multi-core fiber MF2, (2) the core a2 of the first multi-core fiber MF1 is connected to the core a2 of the second multi-core fiber MF2, (3) the core a3 of the first multi-core fiber MF1 is connected to the core a3 of the second multi-core fiber MF2, and (4) the core a4 of the first multi-core fiber MF1 is connected to the core a4 of the second multi-core fiber MF2. Hereinafter, the connection as above is referred to as “normal connection”. Note that in some cases, a position of the marker c changes depending on a manufacturing lot or a manufacturer. Even in such a case, in a case where the cores a1 to a4 identified in accordance with their distances from the markers c on the end surface σ2 of the first multi-core fiber MF1 and the end surface σ1 of the second multi-core fiber MF2 are connected as described above, this connection is regarded as normal connection, since the positions of the markers c are swapped. Note that “normal connection” may be also referred to as “straight connection”. Note that the “normal connection” may be defined to have the following configuration. That is, the configuration may be defined to be such that (i) each of the plurality of multi-core fibers has an end surface including a cladding, a plurality of cores arranged so as to be axisymmetric with respect to an imaginary symmetry axis, and a marker, (ii) the center of the marker is located in a domain inside a domain including two imaginary lines each connecting the cladding center and two cores and an imaginary circumscribed circle that is centered on the center of the cladding and is circumscribed on the outer shape of the cladding, (iii) the imaginary symmetrical axis exists between the core closest to the marker and the core second closest to the marker, and (iv) existence domains of the center positions of the two markers of two multi-core fibers are swapped with each other with the imaginary symmetrical axis as a boundary.

In the connection illustrated in (c) of FIG. 20, (1) the core a1 of the first multi-core fiber MF1 is connected to the core a2 of the second multi-core fiber MF2, (2) the core a2 of the first multi-core fiber MF1 is connected to the core a1 of the second multi-core fiber MF2, (3) the core a3 of the first multi-core fiber MF1 is connected to the core a4 of the second multi-core fiber MF2, and (4) the core a4 of the first multi-core fiber MF1 is connected to the core a3 of the second multi-core fiber MF2. Hereinafter, the connection as above is referred to as “reverse connection”. Note that in some cases, a position of the marker c changes depending on a manufacturing lot or a manufacturer. Even in such a case, in a case where the cores a1 to a4 identified in accordance with their distances from the markers c on the end surface σ2 of the first multi-core fiber MF1 and the end surface σ2 of the second multi-core fiber MF2 are connected as described above, this connection is regarded as reverse connection, since the positions of the markers c are not swapped. Note that the “reverse connection” may be also referred to as “cross connection”. The “reverse connection” may be defined to have the following configuration. That is, the configuration may be defined to be such that (i) each of the plurality of multi-core fibers has an end surface including a cladding, a plurality of cores arranged so as to be axisymmetric with respect to an imaginary symmetry axis, and a marker, (ii) the center of the marker is located in a domain inside a domain including two imaginary lines each connecting the cladding center and two cores and an imaginary circumscribed circle that is centered on the center of the cladding and is circumscribed on the outer shape of the cladding, (iii) the imaginary symmetrical axis exists between the core closest to the marker and the core second closest to the marker, and (iv) existence domains of the center positions of the two markers of two multi-core fibers are the same with the imaginary symmetrical axis as a boundary.

Next, the following will discuss a multi-core fiber connected body obtained by connecting n multi-core fibers MF1, MF2, . . . and MFn, taking, as an example, the multi-core fiber MF illustrated in (a) of FIG. 20. Such multi-core fiber connected bodies include (1) a normal-type multi-core fiber connected body Cs in which positions of the markers c are swapped in a case where the both end surfaces Σ1 and Σ2 of the multi-core fiber connected body C are each viewed from the front with the multi-core fiber connected body C undergoing no twisting and (2) a reverse-type multi-core fiber connected body Cc in which positions of the markers c are not swapped in a case where the both end surfaces Σ1 and Σ2 of the multi-core fiber connected body Care each viewed from the front with the multi-core fiber connected body C undergoing no twisting.

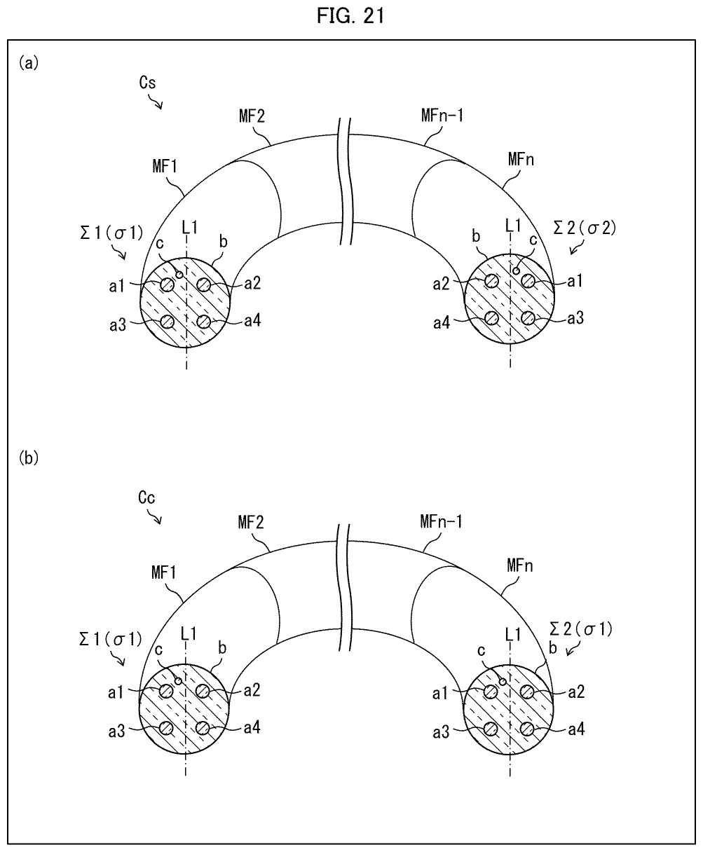

(a) of FIG. 21 illustrates an example of a normal-type multi-core fiber connected body Cs. As in the case of the two multi-core fibers MF1 and MF2 normally connected, in the normal-type multi-core fiber connected body Cs, in a case where the both end surfaces Σ1 and Σ2 are each viewed from the front without twisting, the positions of the markers c are reversed with respect to the straight line L1, which is the axis with respect to which the cores a1 to a4 are axisymmetric. Further, as in the case of the two multi-core fibers MF1 and MF2 normally connected, in the normal-type multi-core fiber connected body Cs, (1) the core a1 of the first multi-core fiber MF1 is connected to the core a1 of the n-th multi-core fiber MFn, (2) the core a2 of the first multi-core fiber MF1 is connected to the core a2 of the n-th multi-core fiber MFn, (3) the core a3 of the first multi-core fiber MF1 is connected to the core a3 of the n-th multi-core fiber MFn, and (4) the core a4 of the first multi-core fiber MF1 is connected to the core a4 of the n-th multi-core fiber MFn. The normal-type multi-core fiber connected body Cs can be obtained by, for example, connecting the n multi-core fibers MF1, MF2, . . . , and MFn so that the number of the connection parts through the reverse connection is an even number. However, the normal-type multi-core fiber connected body Cs is not limited to the multi-core fiber connected body obtained in a manner as described above. The arrangement of the markers c in the intermediate multi-core fibers MF2 to MFn-1 can be made as appropriate. Further, the markers c may be omitted in the multi-core fibers MF2 to MFn-1. This is advantageous in terms of easiness of manufacture of the multi-core fiber connected body itself obtained in a manner as described above.

Note that in some cases, a position of the marker c changes depending on a manufacturing lot or a manufacturer, as described above. Even in such a case, in a case where the cores a1 to a4 identified in accordance with their distances from the markers c on the both end surfaces Σ1 and Σ2 of the multi-core fiber connected body Cs are connected as described above, it is regarded as a normal-type multi-core fiber connected body, since the positions of the markers c are swapped.

(b) of FIG. 21 illustrates an example of the reverse-type multi-core fiber connected body Cc. As in the case of the two multi-core fibers MF1 and MF2 reversely connected, in the reverse-type multi-core fiber connected body Cc, in a case where the both end surfaces Σ1 and Σ2 are each viewed from the front without twisting, the positions of the markers c coincide. Further, as in the case of the two multi-core fibers MF1 and MF2 reversely connected, in the reverse-type multi-core fiber connected body Cc, (1) the core a1 of the first multi-core fiber MF1 is connected to the core a2 of the n-th multi-core fiber MFn, (2) the core a2 of the first multi-core fiber MF1 is connected to the core a1 of the n-th multi-core fiber MFn, (3) the core a3 of the first multi-core fiber MF1 is connected to the core a4 of the n-th multi-core fiber MFn, and (4) the core a4 of the first multi-core fiber MF1 is connected to the core a3 of the n-th multi-core fiber MFn. The reverse-type multi-core fiber connected body Cc can be obtained by, for example, connecting the n multi-core fibers MF1, MF2, . . . , and MFn so that the number of the connection parts through the reverse connection is an odd number. However, the reverse-type multi-core fiber connected body Cc is not limited to the multi-core fiber connected body obtained in a manner as described above. The arrangement of the markers c in the intermediate multi-core fibers MF2 to MFn-1 can be made as appropriate. Further, the markers c may be omitted in the multi-core fibers MF2 to MFn-1. This is advantageous in terms of easiness of manufacture of the multi-core fiber connected body itself obtained in a manner as described above.

Note that in some cases, a position of the marker c changes depending on a manufacturing lot or a manufacturer, as described above. Even in such a case, in a case where the cores a1 to a4 identified in accordance with their distances from the markers c on the both end surfaces Σ1 and Σ2 of the multi-core fiber connected body Cc are connected as described above, it is regarded as a reverse-type multi-core fiber connected body, since the positions of the markers c are not swapped.

Using such a multi-core fiber connected body as a transmission path of an optical communication network may raise the following.

That is, assume a case where after the one end surface Σ1 of the multi-core fiber connected body C has been connected to a first node, the other end surface Σ2 of the multi-core fiber connected body C is connected to a second node. In this case, an operator who connects the other end surface 93 2 of the multi-core fiber connected body C to the second node needs to have two pieces of knowledge. The first one is knowledge on to which ports of the first node the respective cores a1 to a4 on the one end surface Σ1 of the multi-core fiber connected body C are connected. The second one is knowledge on whether the multi-core fiber connected body C is a normal-type multi-core fiber connected body Cs or a reverse-type multi-core fiber connected body Cc. This is because the ports of the second node to which the respective cores a1 to a4 on the other end surface Σ2 of the multi-core fiber connected body C are to be connected differ depending on these pieces of knowledge.

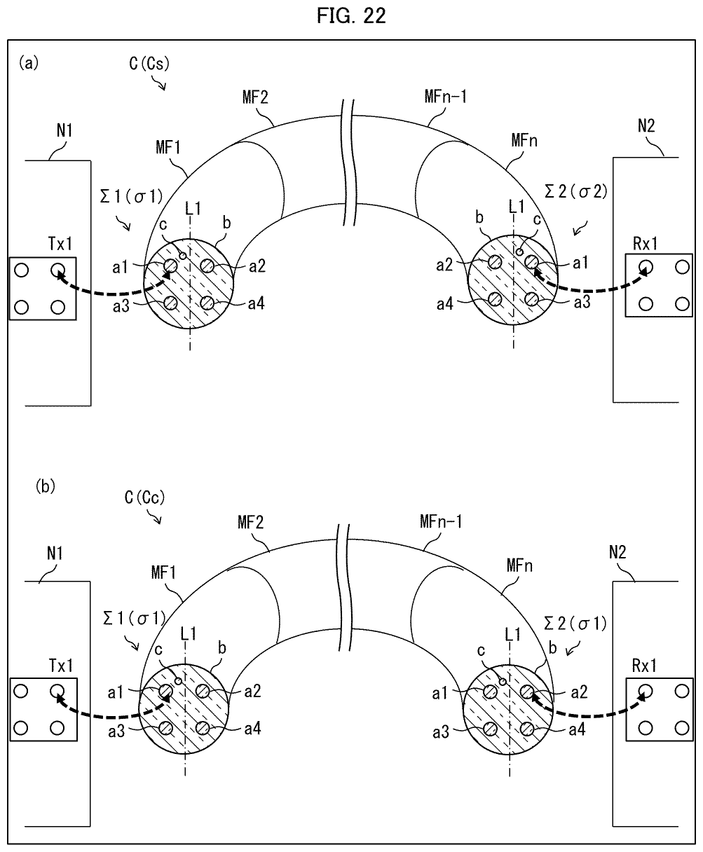

For example, on the assumption that the normal-type multi-core fiber connected body Cs in which the positions of the markers c are swapped on the both end surfaces Σ1 and Σ2 is used as the multi-core fiber connected body C, in a case where the core a1 on the one end surface Σ1 is connected to a transmission port Tx1, the core a1 on the other end surface Σ2 needs to be connected to a reception port Rx1, as illustrated in (a) of FIG. 22. In contrast, on the assumption that the multi-core fiber connected body Cc in which the positions of the markers c are not swapped on the both end surfaces Σ1 and Σ2 is used as the multi-core fiber connected body C, in a case where the core a1 on the one end surface Σ1 is connected to the transmission port Tx1, the core a2 on the other end surface Σ2 needs to be connected to the reception port Rx1, as illustrated in (b) of FIG. 22.

As described above, in a case where a multi-core fiber connected body is used as a transmission path of an optical communication network, an operator needs to have the two pieces of knowledge described above for an operation of connecting the multi-core fiber connected body to a node. This is why it has been difficult to construct or design an optical communication network including a multi-core fiber connected body as a transmission path or to increase or decrease the number of nodes. One or more embodiments eliminate the second knowledge described above, i.e., knowledge on whether the multi-core fiber connected body C is the normal-type multi-core fiber connected body Cs or a reverse-type multi-core fiber connected body Cc and thus facilitate these operations.

### Multi-Core Fiber

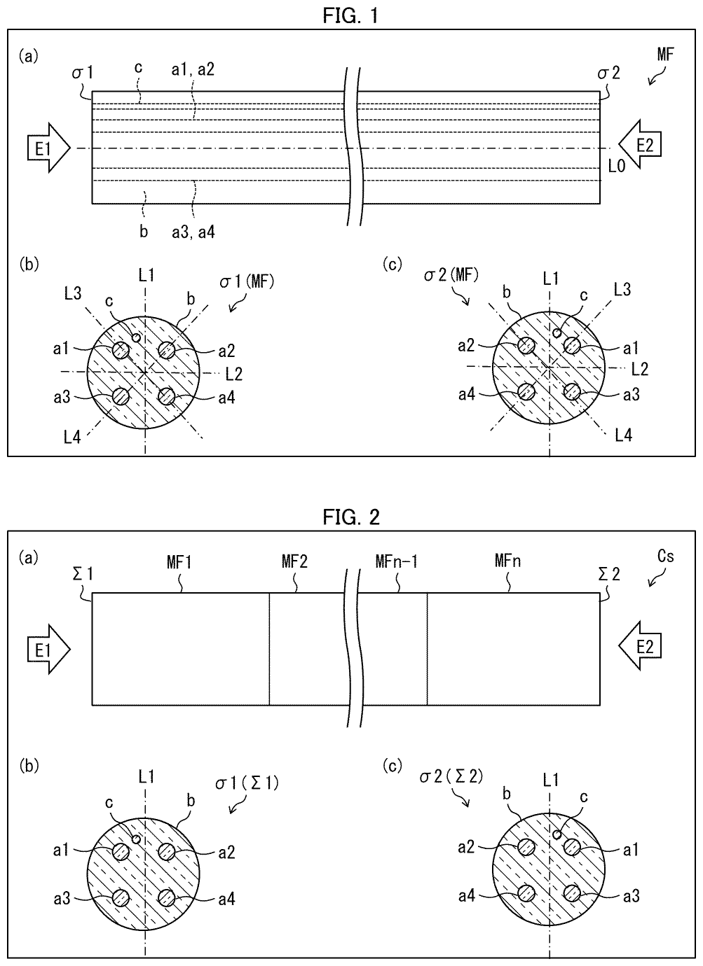

With reference to FIG. 1, the following description will discuss the multi-core fiber MF used in each of the embodiments. In FIG. 1, (a) is a side view illustrating the multi-core fiber MF, (b) is a front view illustrating one end surface σ1 of the multi-core fiber MF viewed in a direction of a sight line E1, and (c) is a front view illustrating the other end surface σ2 of the multi-core fiber MF viewed in a direction of a sight line E2.

The multi-core fiber MF includes n (n is a natural number of not less than two) cores a1 to an and a cladding b. The cladding b is a cylindrical member. The cladding b is made of silica glass, for example. Each core ai (i is a natural number of not less than one and not more than n) is a cylindrical-shape area that resides inside the cladding b, that has a higher refractive index than that of the cladding b, and that extends in a direction in which the cladding b extends. Each core ai is made of, for example, silica glass doped with an updopant such as germanium. The cladding b only needs to be a columnar shape, and may have any cross-sectional shape. The cross-sectional shape of the cladding b may be a polygonal shape such as a quadrangular shape or a hexagonal shape or may be a barrel shape.

On each of the end surfaces σ1 and σ2, the cores a1 to an are arranged so as to be axisymmetric with respect to the axis L1 which is orthogonal to a central axis L0 of the multi-core fiber MF.

The multi-core fiber MF further includes a marker c. The marker c is a columnar-shape area that resides inside the cladding b, that has a different refractive index from that of the cladding b, and that extends in a direction in which the cladding b extends. The cross-sectional shape of the marker c may be any shape. For example, the cross-sectional shape of the marker c may be a circular shape, a triangular shape, or a quadrangular shape. The marker c is made of, for example, silica glass doped with a downdopant such as fluorine or boron. In this case, the marker c has a refractive index lower than that of the cladding b. Alternatively, the marker c is made of silica glass doped with an updopant such as germanium, aluminum, phosphorus, or chlorine. In this case, the marker c has a refractive index higher than that of the cladding b. The marker c may be formed by, for example, a drilling process or a stack-and-draw process. The outer diameter of the marker c is usually smaller than the outer diameter of the core ai.

On each of the end surfaces σ1 and σ2, a center of the marker c is positioned so as to avoid the axis L1. In other words, on each of the end surfaces σ1 and σ2, the center of the marker c is positioned at a location that does not overlap the axis L1. Note that the position of the marker c only needs to be defined so that the center of the marker c can avoid the axis L1. The marker c may partially overlap the axis L1. This makes it possible to uniquely identify the cores a1 to a4 on the end surfaces σ1 and σ2. In the example illustrated in FIG. 1, the core closest to the marker c is the core a1, the core second closest to the marker c is the core a2, the core third closest to the marker c is the core a3, and the core farthest from the marker c is the core a4.

Note that the cores a1 to a4 of the multi-core fiber MF illustrated in FIG. 1 can be regarded as being disposed so as to be axisymmetric with respect to an axis L2, or can also be regarded as being arranged so as to be axisymmetric with respect to an axis L3, or can also be regarded as arranged so as to be axisymmetric with respect to an axis L4. Here, the axis L2 is an axis orthogonal to both the central axis L0 and the axis L1. The axes L3 and L4 are each an axis that is orthogonal to the central axis L0 and that has an angle of 45 degrees with the axis L1.

### Multi-Core Fiber Connected Body

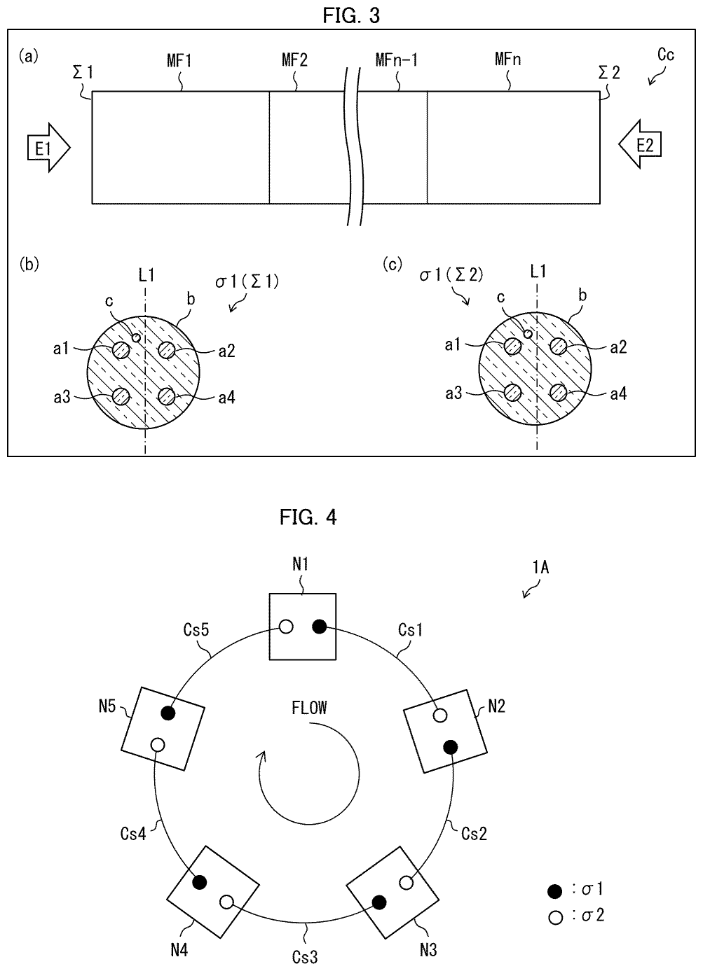

With reference to FIGS. 2 and 3, the following description will discuss the multi-core fiber connected body Cs used in Example 1 of one or more embodiments and the multi-core fiber connected body Cc used in Example 2 of one or more embodiments.

The multi-core fiber connected body Cs illustrated in FIG. 2 is a normal-type multi-core fiber connected body in which the positions of the markers c are swapped on the both end surfaces thereof, and is obtained by, for example, connecting n (n is a natural number of not less than two) multi-core fibers MF (hereinafter, referred to as “multi-core fibers MF1 to MFn”). In FIG. 2, (a) is a side view illustrating the normal-type multi-core fiber connected body Cs, (b) is a front view illustrating one end surface Σ1 of the normal-type multi-core fiber connected body Cs viewed in a direction of the sight line E1, and (c) is a front view illustrating the other end surface Σ2 of the normal-type multi-core fiber connected body Cs viewed in a direction of the sight line E2.

In the normal-type multi-core fiber connected body Cs, the one end surface Σ1 is the end surface σ1 of the multi-core fiber MF1, the other end surface Σ2 is the end surface σ2 of the multi-core fiber MFn (it is alternatively possible that the one end surface Σ1 is the end surface σ2 of the multi-core fiber MF1 and the other end surface Σ2 is the end surface σ1 of the multi-core fiber MFn). Here, the core a1 of the one end surface Σ1 is optically connected to the core a1 of the other end surface Σ2. The core a2 of the one end surface Σ1 is optically connected to the core a2 of the other end surface Σ2. The core a3 of the one end surface Σ1 is optically connected to the core a3 of the other end surface Σ2. The core a4 of the one end surface Σ1 is optically connected to the core a4 of the other end surface Σ2. As illustrated in (b) and (c) of FIG. 2, in a case where the both end surfaces Σ1 and Σ2 of the normal-type multi-core fiber connected body Cs are each viewed from the front without twisting, the positions of the markers c are reversed with respect to the straight line L1, which is the axis with respect to which the cores a1 to a4 are axisymmetric.

Note that in some cases, a position of the marker c changes depending on a manufacturing lot or a manufacturer. Even in such a case, in a case where the cores a1 to a4 identified in accordance with their distances from the markers c on the both end surfaces Σ1 and Σ2 of the multi-core fiber connected body Cs are connected as described above, it is regarded as a normal-type fiber connected body, sine the positions of the markers c are swapped.

Note that the normal-type multi-core fiber connected body Cs is obtained by, for example, normally connecting the two multi-core fibers MF1 and MF2. Alternatively, the normal-type multi-core fiber connected body Cs is obtained by connecting not less than three multi-core fibers MF1 to MFn so that the number of the points through the reverse connection is an even number. However, the normal-type multi-core fiber connected body Cs is not limited to the one obtained in a manner as described above. That is, in the intermediate multi-core fibers MF2 to MFn-1, the arrangement of the markers c is made as appropriate. Further, in the multi-core fibers MF2 to MFn-1, the markers c may be omitted.

The multi-core fiber connected body Cc illustrated in FIG. 3 is a reverse-type multi-core fiber connected body in which the positions of the markers c are not swapped on both end surfaces thereof, and is obtained by, for example, connecting the n multi-core fibers MF1 to MFn. In FIG. 3, (a) is a side view illustrating the reverse-type multi-core fiber connected body Cc, (b) is a front view illustrating the one end surface Σ1 of the reverse-type multi-core fiber connected body Cc viewed in a direction of the sight line E1, and (c) is a front view illustrating the other end surface Σ2 of the reverse-type multi-core fiber connected body Cc viewed in a direction of the sight line E2.

In the reverse-type multi-core fiber connected body Cc, the one end surface Σ1 is the end surface σ1 of the multi-core fiber MF1, the other end surface Σ2 is the end surface σ1 of the multi-core fiber MFn (it is alternatively possible that the one end surface Σ1 is the end surface σ2 of the multi-core fiber MF1 and the other end surface Σ2 is the end surface σ2 of the multi-core fiber MFn). Here, the core a1 of the one end surface Σ1 is optically connected to the core a2 of the other end surface Σ2. The core a2 of the one end surface Σ1 is optically connected to the core a1 of the other end surface Σ2. The core a3 of the one end surface Σ1 is optically connected to the core a4 of the other end surface Σ2. The core a4 of the one end surface Σ1 is optically connected to the core a3 of the other end surface Σ2. As illustrated in (b) and (c) of FIG. 3, when the both end surfaces Σ1 and Σ2 of the reverse-type multi-core fiber connected body Cc are each viewed from the front without twisting, the positions of the markers c coincide.

Note that in some cases, a position of the marker c changes depending on a manufacturing lot or a manufacturer. Even in such a case, in a case where the cores a1 to a4 identified in accordance with their distances from the markers c on the both end surfaces Σ1 and Σ2 of the multi-core fiber connected body Cc are connected as described above, it is regarded as a reverse-type multi-core fiber connected body, since the positions of the markers c are not swapped.

Note that the reverse-type multi-core fiber connected body Cc is obtained by, for example, reversely connecting the two multi-core fibers MF1 and MF2. Alternatively, the reverse-type multi-core fiber connected body Cc is obtained by connecting not less than three multi-core fibers MF1 to MFn so that the number of the points through the reverse connection is an odd number. However, the reverse-type multi-core fiber connected body Cc is not limited to the one obtained in a manner as described above. That is, in the intermediate multi-core fibers MF2 to MFn-1, the arrangement of the markers c is made as appropriate. Further, in the intermediate multi-core fibers MF2 to MFn-1, the markers c may be omitted.

### EXAMPLE 1

With reference to FIGS. 4 to 11, the following description will discuss optical communication networks 1A to 1H in accordance with Example 1 of one or more embodiments. Each of the optical communication networks 1A to 1H in accordance with the present example is an optical communication network including not less than three nodes, and includes a domain in which all of a plurality of transmission paths that connect nodes within the domain are constituted by multi-core fibers or multi-core fiber connected bodies in which positions of markers on both end surfaces thereof are swapped.

### First Specific Example

With reference to FIG. 4, the following description will discuss a first specific example of an optical communication network in accordance with the present example (hereinafter, referred to as “optical communication network 1A”).

The optical communication network 1A in accordance with the present specific example includes a plurality of nodes N1 to N5 and a plurality of multi-core fiber connected bodies Cs1 to Cs5 connecting the nodes. The nodes N1 to N5 and the multi-core fiber connected bodies Cs1 to Cs5 constitute a ring-type network. Each of the multi-core fiber connected bodies Cs1 to Cs5 is a normal-type multi-core fiber connected body.

A characteristic of the optical communication network 1A is that all of the transmission paths thereof connecting the nodes are constituted by normal-type multi-core fiber connected bodies, that is, multi-core fiber connected bodies in which the positions of the markers c on the both end surfaces are swapped.

This enables an operator who connects one end of the multi-core fiber connected body to a node in order to construct or expand the optical communication network 1A to preliminarily know that the multi-core fiber connected body is of a normal type. As a result, it is possible to carry out the connection operation only with knowledge concerning the connection destinations of the cores on the other end of the multi-core fiber connected body.

An additional characteristic of the optical communication network 1A is that the directions of the multi-core fiber connected bodies Cs1 to Cs5 are aligned so as to prevent the positions of the markers on the end surfaces located on a downstream side of a flow following the ring-type network clockwise from being swapped. In the example illustrated, the directions of the multi-core fiber connected bodies Cs1 to Cs5 are aligned so that all the end surfaces located on a downstream side of the flow following the ring-type network clockwise are the end surfaces σ2.

This enables an operator who connects one end of the multi-core fiber connected body to a node in order to construct or expand the optical communication network 1A to preliminarily know whether the one end of the multi-core fiber connected body at hand is the end surface σ1 or the end surface σ2, as well as know that the multi-core fiber connected body is of a normal type. This makes it possible to more easily carry out the connection operation.

Note that, as in the case of the multi-core fiber connected bodies Cs1 to Cs5, in the multi-core fiber MF, the positions of the markers c on the both end surfaces are swapped. Thus, also in an optical communication network in which some or all of the multi-core fiber connected bodies Cs1 to Cs5 are replaced with the multi-core fibers MF, it is possible to attain the same effect as that described above.

### Second Specific Example

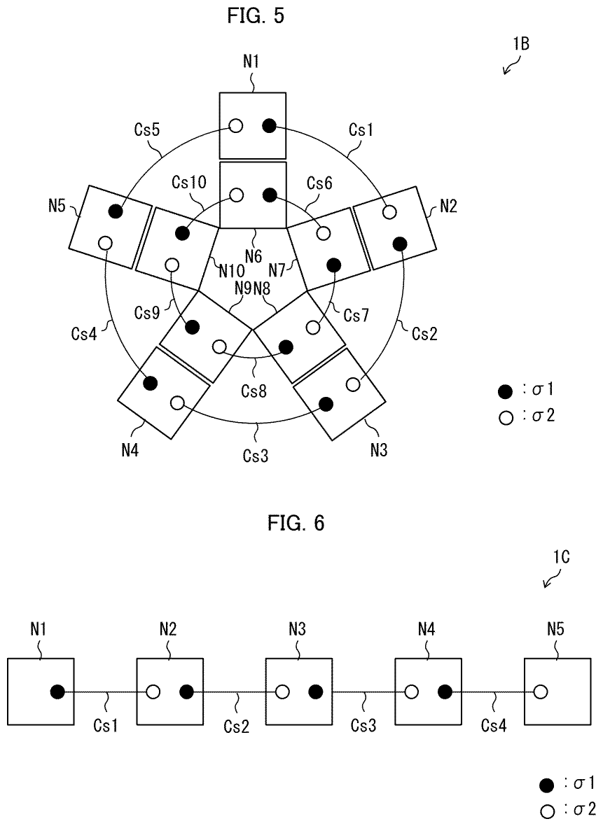

With reference to FIG. 5, the following description will discuss a second specific example of an optical communication network in accordance with the present example (hereinafter, referred to as “optical communication network 1B”).

The optical communication network 1B in accordance with the present specific example includes a plurality of nodes N1 to N10 and a plurality of multi-core fiber connected bodies Cs1 to Cs10 connecting the nodes. The nodes N1 to N5 and the multi-core fiber connected bodies Cs1 to Cs5 constitute a first ring-type network. Further, the nodes N6 to N10 and the multi-core fiber connected bodies Cs6 to Cs10 constitute a second ring-type network surrounded by the first ring-type network. That is, the nodes N1 to N10 and the multi-core fiber connected bodies Cs1 to Cs10 constitute a dual ring-type network. Each of the multi-core fiber connected bodies Cs1 to Cs10 is a normal-type multi-core fiber connected body.

A characteristic of the optical communication network 1B is that all of the transmission paths thereof connecting the nodes are constituted by normal-type multi-core fiber connected bodies, that is, multi-core fiber connected bodies in which the positions of the markers c on the both end surfaces are swapped.

This enables an operator who connects one end of the multi-core fiber connected body to a node in order to construct or expand the optical communication network 1B to preliminarily know that the multi-core fiber connected body is of a normal type. As a result, it is possible to carry out the connection operation only with knowledge concerning the connection destinations of the cores on the other end of the multi-core fiber connected body.

Additional characteristics of the optical communication network 1B are that (1) the directions of the multi-core fiber connected bodies Cs1 to Cs5 are aligned so as to prevent the positions of the markers on the end surfaces located on a downstream side of a flow following the first ring-type network clockwise from being swapped and (2) that the directions of the multi-core fiber connected bodies Cs6 to Cs10 are aligned so as to prevent the positions of the markers on the end surfaces located on a downstream side of a flow following the second ring-type network clockwise from being swapped. In the example illustrated, the directions of the multi-core fiber connected bodies Cs1 to Cs5 and the directions of the multi-core fiber connected bodies Cs6 to Cs10 are both aligned such that all the end surfaces located on downstream sides of the flows following the ring-type networks clockwise are the end surfaces σ2.

This enables an operator who connects one end of the multi-core fiber connected body to a node in order to construct or expand the optical communication network 1B to preliminarily know whether the one end of the multi-core fiber connected body at hand is the end surface σ1 or the end surface σ2, as well as know that the multi-core fiber connected body is of a normal type. This makes it possible to more easily carry out the connection operation.

Note that it is also possible that the directions of the multi-core fiber connected bodies Cs1 to Cs5 or the directions of the multi-core fiber connected bodies Cs6 to Cs10 may be aligned so that all the end surfaces located on a downstream side of the flow following the ring-type network clockwise are the end surfaces σ1. However, in this case, an operator who connects the one end of the multi-core fiber connected body to a node in order to construct or expand the optical communication network 1B needs to have knowledge on whether the network that the worker is handling is the first ring-type network or the second ring-type network.

Note that, as in the case of the multi-core fiber connected bodies Cs1 to Cs10, in the multi-core fiber MF, the positions of the markers c on the both end surfaces are swapped. Thus, also in an optical communication network in which some or all of the multi-core fiber connected bodies Cs1 to Cs10 are replaced with the multi-core fibers MF, it is possible to attain the same effect as that described above.

### Third Specific Example

With reference to FIG. 6, the following description will discuss a third specific example of an optical communication network in accordance with the present example (hereinafter, referred to as “optical communication network 1C”).

The optical communication network 1C in accordance with the present specific example includes a plurality of nodes N1 to N5 and a plurality of multi-core fiber connected bodies Cs1 to Cs4 connecting the nodes. The nodes N1 to N5 and the multi-core fiber connected bodies Cs1 to Cs4 constitute a line-type network. Each of the multi-core fiber connected bodies Cs1 to Cs4 is a normal-type multi-core fiber connected body.

A characteristic of the optical communication network 1C is that all of the transmission paths thereof connecting the nodes are constituted by normal-type multi-core fiber connected bodies, that is, multi-core fiber connected bodies in which the positions of the markers c on the both end surfaces are swapped.

This enables an operator who connects one end of the multi-core fiber connected body to a node in order to construct or expand the optical communication network 1C to preliminarily know that the multi-core fiber connected body is of a normal type. As a result, it is possible to carry out the connection operation only with knowledge concerning the connection destinations of the cores on the other end of the multi-core fiber connected body.

An additional characteristic of the optical communication network 1C is that the directions of the multi-core fiber connected bodies Cs1 to Cs4 are aligned so as to prevent the positions of the markers on the end surfaces located on a downstream side of a flow following the line-type network from one end (the left end in FIG. 6) thereof to the other end (the right end in FIG. 6) thereof from being swapped. In the example illustrated, the directions of the multi-core fiber connected bodies Cs1 to Cs4 are aligned so that all the end surfaces located on a downstream side of the flow from the line-type network from one end thereof to the other end thereof are the end surfaces σ2.

This enables an operator who connects one end of the multi-core fiber connected body to a node in order to construct or expand the optical communication network 1C to preliminarily know whether the one end of the multi-core fiber connected body at hand is the end surface σ1 or the end surface σ2, as well as know that the multi-core fiber connected body is of a normal type. This makes it possible to more easily carry out the connection operation.

Note that, as in the case of the multi-core fiber connected bodies Cs1 to Cs4, in the multi-core fiber MF, the positions of the markers c on the both end surfaces are swapped. Thus, also in an optical communication network in which some or all of the multi-core fiber connected bodies Cs1 to Cs4 are replaced with the multi-core fibers MF, it is possible to attain the same effect as that described above.

### Fourth Specific Example

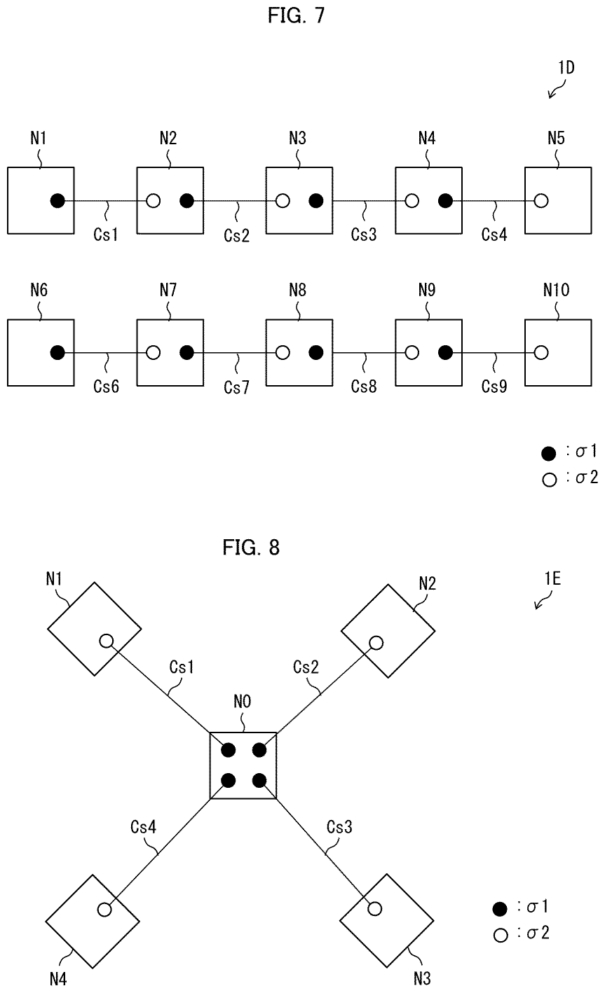

With reference to FIG. 7, the following description will discuss a fourth specific example of an optical communication network in accordance with the present example (hereinafter, referred to as “optical communication network 1D”).

The optical communication network 1D in accordance with the present specific example includes a plurality of nodes N1 to N10 and a plurality of multi-core fiber connected bodies Cs1 to Cs4 and Cs6 to Cs9 connecting the nodes. The nodes N1 to N5 and the multi-core fiber connected bodies Cs1 to Cs4 constitute a first line-type network. The nodes N6 to N10 and the multi-core fiber connected bodies Cs6 to Cs9 constitute a second line-type network running side by side parallel to the first line-type network. That is, the nodes N1 to N10 and the multi-core fiber connected bodies Cs1 to Cs4 and Cs6 to Cs9 constitute a dual line-type network. Each of the multi-core fiber connected bodies Cs1 to Cs4 and Cs6 to Cs9 is a normal-type multi-core fiber connected body.

A characteristic of the optical communication network 1D is that all of the transmission paths thereof connecting the nodes are constituted by normal-type multi-core fiber connected bodies, that is, multi-core fiber connected bodies in which the positions of the markers c on the both end surfaces are swapped.

This enables an operator who connects one end of the multi-core fiber connected body to a node in order to construct or expand the optical communication network 1D to preliminarily know that the multi-core fiber connected body is of a normal type. As a result, it is possible to carry out the connection operation only with knowledge concerning the connection destinations of the cores on the other end of the multi-core fiber connected body.

Additional characteristics of the optical communication network 1D are (1) that the directions of the multi-core fiber connected bodies Cs1 to Cs4 are aligned so as to prevent the positions of the markers on the end surfaces located on a downstream side of a flow following the first line-type network from one end thereof (the left end in FIG. 6) to the other end thereof (the right end in FIG. 6) from being swapped and (2) that the directions of the multi-core fiber connected bodies Cs6 to Cs9 are aligned so as to prevent the positions of the markers on the end surfaces located on a downstream side of a flow following the second line-type network from one end thereof (the left end in FIG. 6) to the other end thereof (the right end in FIG. 6) from being swapped. In the example illustrated, the directions of the multi-core fiber connected bodies Cs1 to Cs4 and the directions of the multi-core fiber connected bodies Cs6 to Cs9 are both aligned so that all the end surfaces located on downstream sides of the flows following the line-type networks from the one end thereof to the other end thereof are the end surfaces σ2.

This enables an operator who connects one end of the multi-core fiber connected body to a node in order to construct or expand the optical communication network 1D to preliminarily know whether the one end of the multi-core fiber connected body at hand is the end surface σ1 or the end surface σ2, as well as know that the multi-core fiber connected body is of a normal type. This makes it possible to more easily carry out the connection operation.

Note that it is also possible that the directions of the multi-core fiber connected bodies Cs1 to Cs4 or the directions of the multi-core fiber connected bodies Cs6 to Cs9 may be aligned so that all the end surfaces located on a downstream side of the flow following the line-type network from the one end thereof to the other end thereof are the end surfaces σ1. However, in this case, an operator who connects the one end of the multi-core fiber connected body to a node in order to construct or expand the optical communication network 1D needs to have knowledge on whether the network that the worker is handling is the first line-type network or the second line-type network.

Note that, as in the case of the multi-core fiber connected bodies Cs1 to Cs4 and Cs6 to Cs9, in the multi-core fiber MF, the positions of the markers c on the both end surfaces are swapped. Thus, also in an optical communication network in which some or all of the multi-core fiber connected bodies Cs1 to Cs4 and Cs6 to Cs9 are replaced with the multi-core fibers MF, it is possible to attain the same effect as that described above.

### Fifth Specific Example

With reference to FIG. 8, the following description will discuss a fifth specific example of an optical communication network in accordance with the present example (hereinafter, referred to as “optical communication network 1E”).

The optical communication network 1E in accordance with the present specific example includes a plurality of nodes N0 to N4 and a plurality of multi-core fiber connected bodies Cs1 to Cs4 connecting the nodes. The nodes N0 to N4 and the multi-core fiber connected bodies Cs1 to Cs4 constitute a star-type network including the node N0 as a center node. Each of the multi-core fiber connected bodies Cs1 to Cs4 is a normal-type multi-core fiber connected body.

A characteristic of the optical communication network 1E is that all of the transmission paths thereof connecting the nodes are constituted by normal-type multi-core fiber connected bodies, that is, multi-core fiber connected bodies in which the positions of the markers c on the both end surfaces are swapped.

This enables an operator who connects one end of the multi-core fiber connected body to a node in order to construct or expand the optical communication network 1E to preliminarily know that the multi-core fiber connected body is of a normal type. As a result, it is possible to carry out the connection operation only with knowledge concerning the connection destinations of the cores on the other end of the multi-core fiber connected body.

An additional characteristic of the optical communication network 1E is that the directions of the multi-core fiber connected bodies Cs1 to Cs4 are aligned so as to prevent the positions of the markers on the end surfaces located on downstream sides of flows away from the center node (node N0) of the star-type network from being swapped. In the example illustrated, the directions of the multi-core fiber connected bodies Cs1 to Cs4 are aligned so that all the end surfaces located on downstream sides of the flows away from the center node of the star-type network are the end surfaces σ2.

This enables an operator who connects one end of the multi-core fiber connected body to a node in order to construct or expand the optical communication network 1E to preliminarily know whether the one end of the multi-core fiber connected body at hand is the end surface σ1 or the end surface σ2, as well as know that the multi-core fiber connected body is of a normal type. This makes it possible to more easily carry out the connection operation.

Note that, as in the case of the multi-core fiber connected bodies Cs1 to Cs4, in the multi-core fiber MF, the positions of the markers c on the both end surfaces are swapped. Thus, also in an optical communication network in which some or all of the multi-core fiber connected bodies Cs1 to Cs4 are replaced with the multi-core fibers MF, it is possible to attain the same effect as that described above.

### Sixth Specific Example

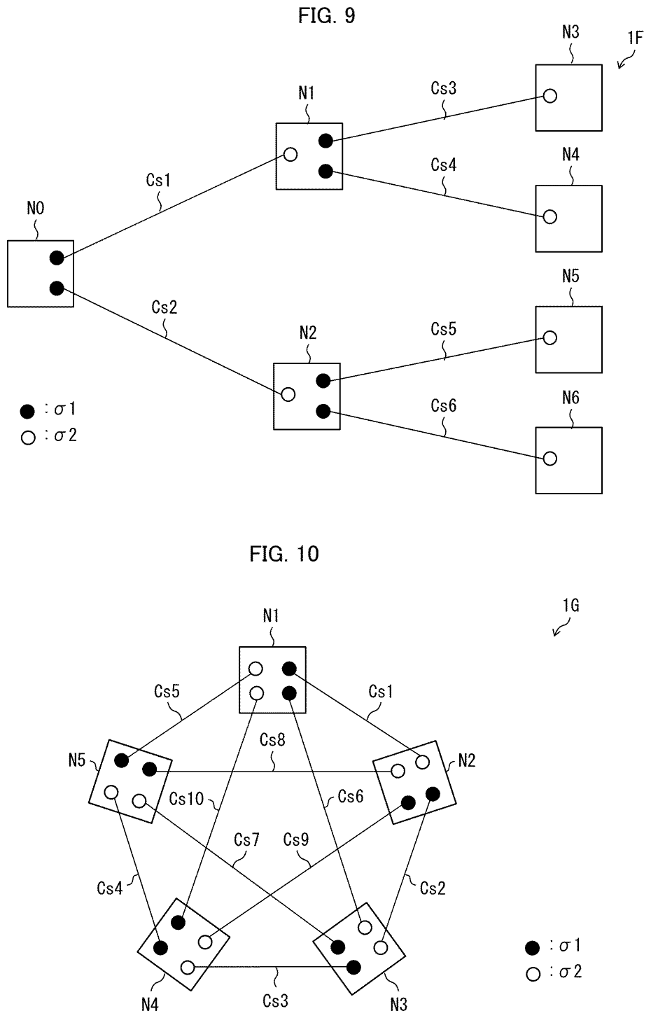

With reference to FIG. 9, the following description will discuss a sixth specific example of an optical communication network in accordance with the present example (hereinafter, referred to as “optical communication network 1F”).

The optical communication network 1F in accordance with the present specific example includes a plurality of nodes N0 to N6 and a plurality of multi-core fiber connected bodies Cs1 to Cs6 connecting the nodes. The nodes N0 to N6 and the multi-core fiber connected bodies Cs1 to Cs6 constitute a tree-type network including the node N0 as a root node. Each of the multi-core fiber connected bodies Cs1 to Cs6 is a normal-type multi-core fiber connected body.

A characteristic of the optical communication network 1F is that all of the transmission paths thereof connecting the nodes are constituted by normal-type multi-core fiber connected bodies, that is, multi-core fiber connected bodies in which the positions of the markers c on the both end surfaces are swapped.

This enables an operator who connects one end of the multi-core fiber connected body to a node in order to construct or expand the optical communication network 1F to preliminarily know that the multi-core fiber connected body is of a normal type. As a result, it is possible to carry out the connection operation only with knowledge concerning the connection destinations of the cores on the other end of the multi-core fiber connected body.

An additional characteristic of the optical communication network 1F is that the directions of the multi-core fiber connected bodies Cs1 to Cs6 are aligned so as to prevent the positions of the markers on the end surfaces located on downstream sides of flows away from the root node (node N0) of the tree-type network from being swapped. In the example illustrated, the directions of the multi-core fiber connected bodies Cs1 to Cs6 are aligned so that all the end surfaces located on downstream sides of the flows away from the root node of the tree-type network are the end surfaces σ2.

This enables an operator who connects one end of the multi-core fiber connected body to a node in order to construct or expand the optical communication network 1F to preliminarily know whether the one end of the multi-core fiber connected body at hand is the end surface σ1 or the end surface σ2, as well as know that the multi-core fiber connected body is of a normal type. This makes it possible to more easily carry out the connection operation.

Note that, as in the case of the multi-core fiber connected bodies Cs1 to Cs6, in the multi-core fiber MF, the positions of the markers c on the both end surfaces are swapped. Thus, also in an optical communication network in which some or all of the multi-core fiber connected bodies Cs1 to Cs6 are replaced with the multi-core fibers MF, it is possible to attain the same effect as that described above.

### Seventh Specific Example

With reference to FIG. 10, the following description will discuss a seventh specific example of an optical communication network in accordance with the present example (hereinafter, referred to as “optical communication network 1G”).

The optical communication network 1G in accordance with the present specific example includes a plurality of nodes N1 to N5 and a plurality of multi-core fiber connected bodies Cs1 to Cs10 connecting the nodes. The nodes N1 to N5 and the multi-core fiber connected bodies Cs1 to Cs10 constitute a fully connected-type network. Each of the multi-core fiber connected bodies Cs1 to Cs6 is a normal-type multi-core fiber connected body.

A characteristic of the optical communication network 1G is that all of the transmission paths thereof connecting the nodes are constituted by normal-type multi-core fiber connected bodies, that is, multi-core fiber connected bodies in which the positions of the markers c on the both end surfaces are swapped.

This enables an operator who connects one end of the multi-core fiber connected body to a node in order to construct or expand the optical communication network 1G to preliminarily know that the multi-core fiber connected body is of a normal type. As a result, it is possible to carry out the connection operation only with knowledge concerning the connection destinations of the cores on the other end of the multi-core fiber connected body.

### Eighth Specific Example

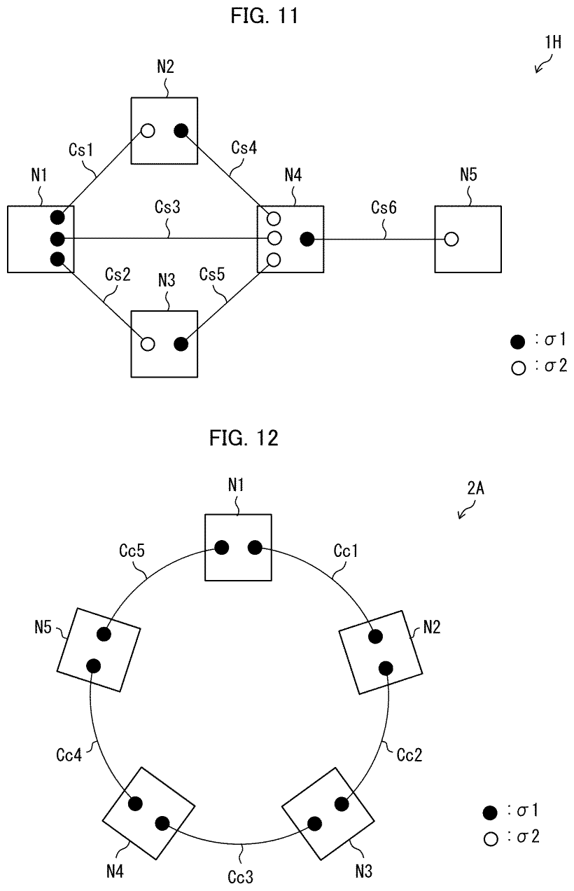

With reference to FIG. 11, the following description will discuss an eighth specific example of an optical communication network in accordance with the present example (hereinafter, referred to as “optical communication network 1H”).

The optical communication network 1H in accordance with the present specific example includes a plurality of nodes N1 to N5 and a plurality of multi-core fiber connected bodies Cs1 to Cs6 connecting the nodes. The nodes N1 to N5 and the multi-core fiber connected bodies Cs1 to Cs6 constitute a mesh-type network. Each of the multi-core fiber connected bodies Cs1 to Cs6 is a normal-type multi-core fiber connected body.

A characteristic of the optical communication network 1H is that all of the transmission paths thereof connecting the nodes are constituted by normal-type multi-core fiber connected bodies, that is, multi-core fiber connected bodies in which the positions of the markers c on the both end surfaces are swapped.

This enables an operator who connects one end of the multi-core fiber connected body to a node in order to construct or expand the optical communication network 1H to preliminarily know that the multi-core fiber connected body is of a normal type. As a result, it is possible to carry out the connection operation only with knowledge concerning the connection destinations of the cores on the other end of the multi-core fiber connected body.

### EXAMPLE 2

With reference to FIGS. 12 to 19, the following description will discuss optical communication networks 2A to 2H in accordance with Example 2 of one or more embodiments. Each of the optical communication networks 2A to 2H in accordance with the present example is an optical communication network including not less than three nodes, and includes a domain in which all of a plurality of transmission paths that connect nodes within the domain are constituted by multi-core fiber connected bodies in which positions of markers on both end surfaces thereof are not swapped.

### First Specific Example

With reference to FIG. 12, the following description will discuss a first specific example of an optical communication network in accordance with the present example (hereinafter, referred to as “optical communication network 2A”).

The optical communication network 2A in accordance with the present specific example includes a plurality of nodes N1 to N5 and a plurality of multi-core fiber connected bodies Cc1 to Cc5 connecting the nodes. The nodes N1 to N5 and the multi-core fiber connected bodies Cc1 to Cc5 constitute a ring-type network. Each of the multi-core fiber connected bodies Cc1 to Cc5 is a reverse-type multi-core fiber connected body.

A characteristic of the optical communication network 2A is that all of the transmission paths thereof connecting the nodes are constituted by reverse-type multi-core fiber connected bodies, that is, multi-core fiber connected bodies in which the positions of the markers c on the both end surfaces are not swapped.

This enables an operator who connects one end of the multi-core fiber connected body to a node in order to construct or expand the optical communication network 2A to preliminarily know that the multi-core fiber connected body is of a reverse type. As a result, it is possible to carry out the connection operation only with knowledge concerning the connection destinations of the cores on the other end of the multi-core fiber connected body.

### Second Specific Example

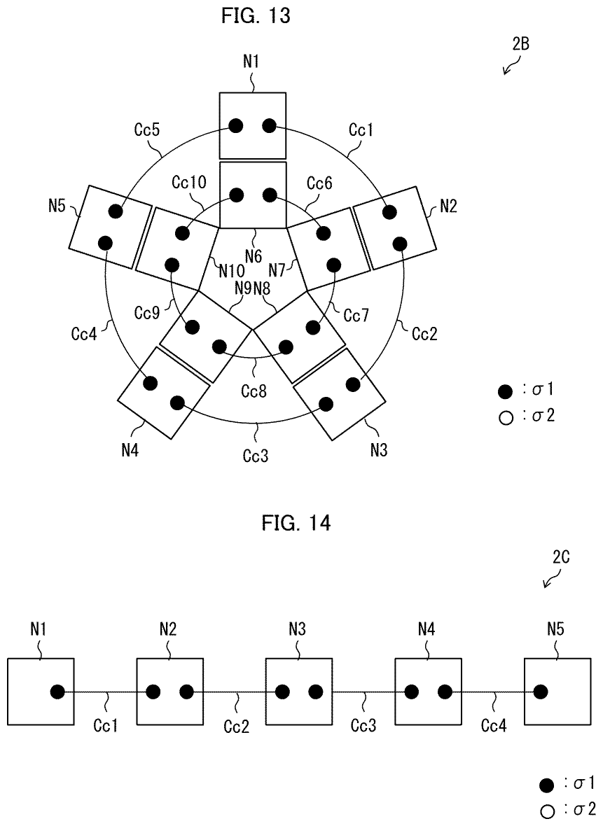

With reference to FIG. 13, the following description will discuss a second specific example of an optical communication network in accordance with the present example (hereinafter, referred to as “optical communication network 2B”).

The optical communication network 2B in accordance with the present specific example includes a plurality of nodes N1 to N10 and a plurality of multi-core fiber connected bodies Cc1 to Cc10 connecting the nodes. The nodes N1 to N5 and the multi-core fiber connected bodies Cc1 to Cc5 constitute a first ring-type network. Further, the nodes N6 to N10 and the multi-core fiber connected bodies Cc6 to Cc10 constitute a second ring-type network surrounded by the first ring-type network. That is, the nodes N1 to N10 and the multi-core fiber connected bodies Cc1 to Cc10 constitute a dual ring-type network. Each of the multi-core fiber connected bodies Cc1 to Cc10 is a reverse-type multi-core fiber connected body.

A characteristic of the optical communication network 2B is that all of the transmission paths thereof connecting the nodes are constituted by reverse-type multi-core fiber connected bodies, that is, multi-core fiber connected bodies in which the positions of the markers c on the both end surfaces are not swapped.

This enables an operator who connects one end of the multi-core fiber connected body to a node in order to construct or expand the optical communication network 2B to preliminarily know that the multi-core fiber connected body is of a reverse type. As a result, it is possible to carry out the connection operation only with knowledge concerning the connection destinations of the cores on the other end of the multi-core fiber connected body.

### Third Specific Example

With reference to FIG. 14, the following description will discuss a third specific example of an optical communication network in accordance with the present example (hereinafter, referred to as “optical communication network 2C”).

The optical communication network 2C in accordance with the present specific example includes a plurality of nodes N1 to N5 and a plurality of multi-core fiber connected bodies Cc1 to Cc4 connecting the nodes. The nodes N1 to N5 and the multi-core fiber connected bodies Cc1 to Cc4 constitute a line-type network. Each of the multi-core fiber connected bodies Cc1 to Cc4 is a reverse-type multi-core fiber connected body.

A characteristic of the optical communication network 2C is that all of the transmission paths thereof connecting the nodes are constituted by reverse-type multi-core fiber connected bodies, that is, multi-core fiber connected bodies in which the positions of the markers c on the both end surfaces are not swapped.

This enables an operator who connects one end of the multi-core fiber connected body to a node in order to construct or expand the optical communication network 2C to preliminarily know that the multi-core fiber connected body is of a reverse type. As a result, it is possible to carry out the connection operation only with knowledge concerning the connection destinations of the cores on the other end of the multi-core fiber connected body.

### Fourth Specific Example

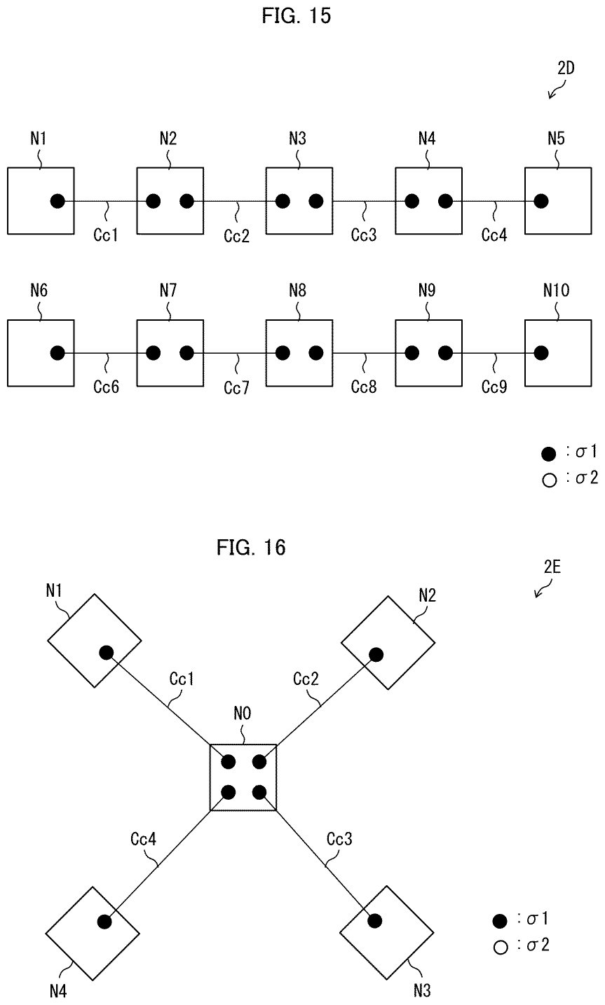

With reference to FIG. 15, the following description will discuss a fourth specific example of an optical communication network in accordance with the present example (hereinafter, referred to as “optical communication network 2D”).

The optical communication network 2D in accordance with the present specific example includes a plurality of nodes N1 to N10 and a plurality of multi-core fiber connected bodies Cc1 to Cc4 and Cc6 to Cc9 connecting the nodes. The nodes N1 to N5 and the multi-core fiber connected bodies Cc1 to Cc4 constitute a first line-type network. The nodes N6 to N10 and the multi-core fiber connected bodies Cc6 to Cc9 constitute a second line-type network running side by side parallel to the first line-type network. That is, the nodes N1 to N10 and the multi-core fiber connected bodies Cc1 to Cc4 and Cc6 to Cc9 constitute a dual line-type network. Each of the multi-core fiber connected bodies Cc1 to Cc4 and Cc6 to Cc9 is a reverse-type multi-core fiber connected body.

A characteristic of the optical communication network 2D is that all of the transmission paths thereof connecting the nodes are constituted by reverse-type multi-core fiber connected bodies, that is, multi-core fiber connected bodies in which the positions of the markers c on the both end surfaces are not swapped.

This enables an operator who connects one end of the multi-core fiber connected body to a node in order to construct or expand the optical communication network 2D to preliminarily know that the multi-core fiber connected body is of a reverse type. As a result, it is possible to carry out the connection operation only with knowledge concerning the connection destinations of the cores on the other end of the multi-core fiber connected body.

### Fifth Specific Example

With reference to FIG. 16, the following description will discuss a fifth specific example of an optical communication network in accordance with the present example (hereinafter, referred to as “optical communication network 2E”).

The optical communication network 2E in accordance with the present specific example includes a plurality of nodes N0 to N4 and a plurality of multi-core fiber connected bodies Cc1 to Cc4 connecting the nodes. The nodes N0 to N4 and the multi-core fiber connected bodies Cc1 to Cc4 constitute a star-type network including the node N0 as a center node. Each of the multi-core fiber connected bodies Cc1 to Cc4 is a reverse-type multi-core fiber connected body.

A characteristic of the optical communication network 2E is that all of the transmission paths thereof connecting the nodes are constituted by reverse-type multi-core fiber connected bodies, that is, multi-core fiber connected bodies in which the positions of the markers c on the both end surfaces are not swapped.

This enables an operator who connects one end of the multi-core fiber connected body to a node in order to construct or expand the optical communication network 2E to preliminarily know that the multi-core fiber connected body is of a reverse type. As a result, it is possible to carry out the connection operation only with knowledge concerning the connection destinations of the cores on the other end of the multi-core fiber connected body.

### Sixth Specific Example

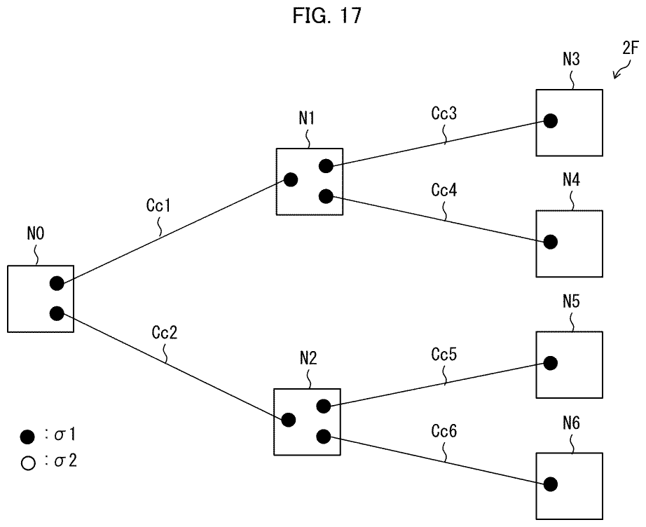

With reference to FIG. 17, the following description will discuss a sixth specific example of an optical communication network in accordance with the present example (hereinafter, referred to as “optical communication network 2F”).

The optical communication network 2F in accordance with the present specific example includes a plurality of nodes N0 to N6 and a plurality of multi-core fiber connected bodies Cc1 to Cc6 connecting the nodes. The nodes N0 to N6 and the multi-core fiber connected bodies Cc1 to Cc6 constitute a tree-type network including the node N0 as a root node. Each of the multi-core fiber connected bodies Cc1 to Cc6 is a reverse-type multi-core fiber connected body.

A characteristic of the optical communication network 2F is that all of the transmission paths thereof connecting the nodes are constituted by reverse-type multi-core fiber connected bodies, that is, multi-core fiber connected bodies in which the positions of the markers c on the both end surfaces are not swapped.

This enables an operator who connects one end of the multi-core fiber connected body to a node in order to construct or expand the optical communication network 2F to preliminarily know that the multi-core fiber connected body is of a reverse type. As a result, it is possible to carry out the connection operation only with knowledge concerning the connection destinations of the cores on the other end of the multi-core fiber connected body.

### Seventh Specific Example

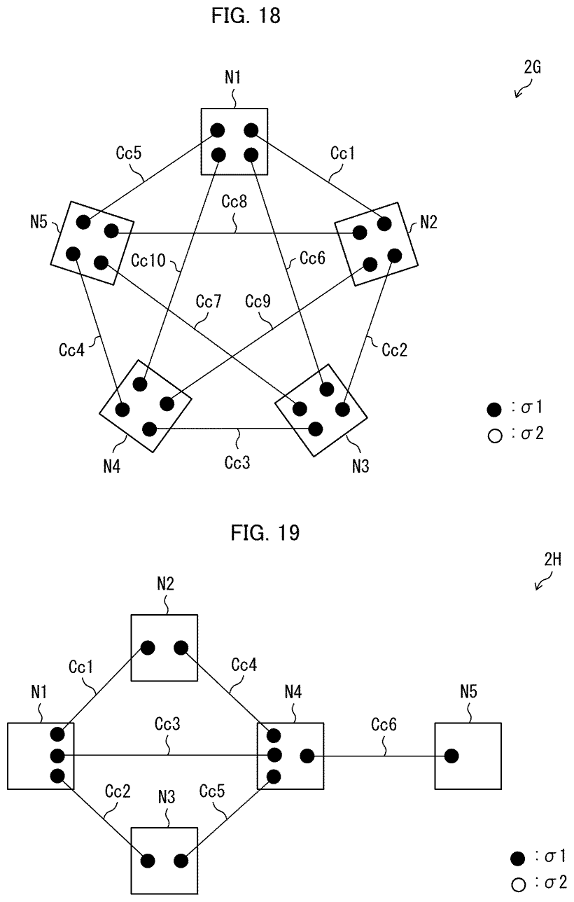

With reference to FIG. 18, the following description will discuss a seventh specific example of an optical communication network in accordance with the present example (hereinafter, referred to as “optical communication network 2G”).

The optical communication network 2G in accordance with the present specific example includes a plurality of nodes N1 to N5 and a plurality of multi-core fiber connected bodies Cc1 to Cc10 connecting the nodes. The nodes N1 to N5 and the multi-core fiber connected bodies Cc1 to Cc10 constitute a fully connected-type network. Each of the multi-core fiber connected bodies Cc1 to Cc6 is a reverse-type multi-core fiber connected body.

A characteristic of the optical communication network 2G is that all of the transmission paths thereof connecting the nodes are constituted by reverse-type multi-core fiber connected bodies, that is, multi-core fiber connected bodies in which the positions of the markers c on the both end surfaces are not swapped.

This enables an operator who connects one end of the multi-core fiber connected body to a node in order to construct or expand the optical communication network 2G to preliminarily know that the multi-core fiber connected body is of a reverse type. As a result, it is possible to carry out the connection operation only with knowledge concerning the connection destinations of the cores on the other end of the multi-core fiber connected body.

### Eighth Specific Example

With reference to FIG. 19, the following description will discuss an eighth specific example of an optical communication network in accordance with the present example (hereinafter, referred to as “optical communication network 2H”).

The optical communication network 2H in accordance with the present specific example includes a plurality of nodes N1 to N5 and a plurality of multi-core fiber connected bodies Cc1 to Cc6 connecting the nodes. The nodes N1 to N5 and the multi-core fiber connected bodies Cc1 to Cc6 constitute a mesh-type network. Each of the multi-core fiber connected bodies Cc1 to Cc6 is a reverse-type multi-core fiber connected body.

A characteristic of the optical communication network 2H is that all of the transmission paths thereof connecting the nodes are constituted by reverse-type multi-core fiber connected bodies, that is, multi-core fiber connected bodies in which the positions of the markers c on the both end surfaces are not swapped.

This enables an operator who connects one end of the multi-core fiber connected body to a node in order to construct or expand the optical communication network 2H to preliminarily know that the multi-core fiber connected body is of a reverse type. As a result, it is possible to carry out the connection operation only with knowledge concerning the connection destinations of the cores on the other end of the multi-core fiber connected body.

Aspects of one or more embodiments can also be expressed as follows:

An optical communication network in accordance with Aspect 1 of one or more embodiments is an optical communication network including not less than three nodes, the optical communication network including a domain in which all of a plurality of transmission paths that connect nodes within the domain are constituted by multi-core fibers or multi-core fiber connected bodies in which positions of markers on both end surfaces of the multi-core fiber connected bodies are swapped or a domain in which all of a plurality of transmission paths that connect nodes within the domain are constituted by multi-core fiber connected bodies in which positions of markers on both end surfaces of the multi-core fiber connected bodies are not swapped.

An optical communication network in accordance with Aspect 2 of one or more embodiments is configured, in the optical communication network in accordance with Aspect 1, such that all of the plurality of transmission paths are constituted by the multi-core fibers or the multi-core fiber connected bodies in which the positions of the markers on the both end surfaces of the multi-core fiber connected bodies are swapped.

An optical communication network in accordance with Aspect 3 of one or more embodiments is configured, in the optical communication network in accordance with Aspect 2, such that: the not less than three nodes and the plurality of transmission paths constitute a ring-type network; and directions of the multi-core fibers or the multi-core fiber connected bodies constituting the plurality of transmission paths are aligned so as to prevent positions of markers on end surfaces that the multi-core fibers or the multi-core fiber connected bodies have and that are located on a downstream side of a flow following the ring-type network clockwise from being swapped.

An optical communication network in accordance with Aspect 4 of one or more embodiments is configured, in the optical communication network in accordance with Aspect 2, such that: the not less than three nodes and the plurality of transmission paths constitute a line-type network; and directions of the multi-core fibers or the multi-core fiber connected bodies constituting the plurality of transmission paths are aligned so as to prevent positions of markers on end surfaces that the multi-core fibers or the multi-core fiber connected bodies have and that are located on a downstream side of a flow following the line-type network from one end to the other end of the line-type network from being swapped.

An optical communication network in accordance with Aspect 5 of one or more embodiments is configured, in the optical communication network in accordance with Aspect 2, such that: the not less than three nodes and the plurality of transmission paths constitute a star-type network; and directions of the multi-core fibers or the multi-core fiber connected bodies constituting the plurality of transmission paths are aligned so as to prevent positions of markers on end surfaces that the multi-core fibers or the multi-core fiber connected bodies have and that are located on downstream sides of flows away from a center node of the star-type network from being swapped.

An optical communication network in accordance with Aspect 6 of one or more embodiments is configured, in the optical communication network in accordance with Aspect 2, such that the not less than three nodes and the plurality of transmission paths constitute a tree-type network; and directions of the multi-core fibers or the multi-core fiber connected bodies constituting the plurality of transmission paths are aligned so as to prevent positions of markers on end surfaces that the multi-core fibers or the multi-core fiber connected bodies have and that are located on a downstream side of a flow away from a root of the tree-type network from being swapped.

An optical communication network in accordance with Aspect 7 of one or more embodiments is configured, in the optical communication network in accordance with Aspect 2, such that the not less than three nodes and the plurality of transmission paths constitute a fully connected-type network or a mesh-type network.

An optical communication network in accordance with Aspect 8 of one or more embodiments is configured, in the optical communication network in accordance with Aspect 1, to include the domain in which all of the plurality of transmission paths are constituted only by the multi-core fiber connected bodies in which the positions of the markers on the both end surfaces of the multi-core fiber connected bodies are not swapped.

A method for manufacturing an optical communication network, in accordance with Aspect 9 of one or more embodiments is a method for manufacturing an optical communication network including not less than three nodes, the method including the step of, as all of a plurality of transmission paths connecting nodes within a specific domain, selecting multi-core fibers or multi-core fiber connected bodies in which positions of markers on both end surfaces of the multi-core fiber connected bodies are swapped or selecting multi-core fiber connected bodies in which positions of markers on both end surfaces of the multi-core fiber connected bodies are not swapped.

### SUPPLEMENTARY REMARKS

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

The present invention is not limited to the connection method for manufacturing a multi-core fiber connected body. For example, fusion-splicing, connector connection, or adhesive connection may be also employed. An optical communication device, such as a FI/FO device, a transmitter/receiver, an isolator, and an optical fiber amplifier may be connected to the multi-core fiber connected body, and a multi-core fiber may be further connected to the multi-core fiber connected body. The node may be provided with an optical communication device. Examples of the optical communication device include a transceiver (transmitter/receiver), a switch, and a multiplexer/demultiplexer. The type of the device is not limited to any particular one.

The number of the nodes in accordance with the above-described embodiments may be two or three or more. In a case where the number of the nodes is not less than three, a plurality of transmission paths between the nodes are present. This increases the degree of freedom in selection of the normal-type or reverse-type multi-core fiber connected bodies between all the nodes. Thus, the operation of connecting the multi-core fiber connected bodies to the nodes by the operator and the configuration of the optical communication network become complicated. Especially in such a case, applying the multi-core fiber connected bodies in accordance with the above-described embodiments to the optical communication network may further facilitate the connection operation for constructing or designing the optical communication network or, increasing and decreasing the number of nodes.

### REFERENCE SIGNS LIST

MF, MF1, M2, . . . . Multi-core fiber
Cs, Cs1, Cs2, . . . . Multi-core fiber connected body (normal type)
Cc, Cc1, Cc2, . . . . Multi-core fiber connected body (reverse type)
N0, N1, N2, . . . . Node
1A, 1B, . . . , 1H Optical communication network
2A, 2B, . . . , 2H Optical communication network

1-9. (canceled)

10. An optical communication network comprising:
three or more nodes; and
a domain in which each of transmission paths, that connects two of the three or more nodes within the domain, is constituted by a multi-core fiber or a multi-core fiber connected body in which positions of markers on both end surfaces of the multi-core fiber connected body are swapped.

11. The optical communication network according to claim 10, wherein
the three or more nodes and the transmission paths constitute a ring-type network,
each of the multi-core fibers or the multi-core fiber connected bodies has a downstream end surface of the both end surfaces located on a downstream side of a flow following the ring-type network clockwise, and
directions of the multi-core fibers or the multi-core fiber connected bodies are aligned such that the position of the marker on the downstream end surface of one of the multi-core fibers or the multi-core fiber connected bodies is not swapped with the position of the mark on the downstream end surface of each of the other multi-core fibers or the other multi-core fiber connected bodies.

12. The optical communication network according to claim 10, wherein
the three or more nodes and the transmission paths constitute a line-type network,
each of the multi-core fibers or the multi-core fiber connected bodies has a downstream end surface of the both end surfaces located on a downstream side of a flow following the line-type network from one end to the other end of the line-type network, and
directions of the multi-core fibers or the multi-core fiber connected bodies are aligned such that the position of the marker on the downstream end surface of one of the multi-core fibers or the multi-core fiber connected bodies is not swapped with the position of the mark on the downstream end surface of each of the other multi-core fibers or the other multi-core fiber connected bodies.

13. The optical communication network according to claim 10, wherein
the three or more nodes and the transmission paths constitute a star-type network,
each of the multi-core fibers or the multi-core fiber connected bodies has a downstream end surface of the both end surfaces located on a downstream side of a flow away from a center node of the star-type network, and
directions of the multi-core fibers or the multi-core fiber connected bodies are aligned such that the position of the marker on the downstream end surface of one of the multi-core fibers or the multi-core fiber connected bodies is not swapped with the position of the mark on the downstream end surface of each of the other multi-core fibers or the other multi-core fiber connected bodies.

14. The optical communication network according to claim 10, wherein
the three or more nodes and the transmission paths constitute a tree-type network,
each of the multi-core fibers or the multi-core fiber connected bodies has a downstream end surface of the both end surfaces located on a downstream side of a flow away from a root of the tree-type network, and
directions of the multi-core fibers or the multi-core fiber connected bodies are aligned such that the position of the marker on the downstream end surface of one of the multi-core fibers or the multi-core fiber connected bodies is not swapped with the position of the mark on the downstream end surface of each of the other multi-core fibers or the other multi-core fiber connected bodies.

15. The optical communication network according to claim 10, wherein the three or more nodes and the transmission paths constitute a fully connected-type network or a mesh-type network.

16. An optical communication network comprising:
three or more nodes; and
a domain in which each of transmission paths, that connects two of the three or more nodes within the domain, is constituted by a multi-core fiber connected body in which positions of markers on both end surfaces of the multi-core fiber connected body are not swapped.

17. A method for manufacturing an optical communication network including three or more nodes, the method comprising:
creating each of transmission paths, that connects two of the three or more nodes within a domain, with a multi-core fiber or a multi-core fiber connected body in which positions of markers on both end surfaces of the multi-core fiber connected body are either swapped or not swapped.
